(19) United States
(12) Patent Application Publication
(10) Pub. No.: US 2021/0305581 A1
(43) Pub. Date: Sep. 30, 2021

(54) CURRENT COLLECTOR WITH SOLID ELECTROLYTE INTERPHASE AND METHOD THEREOF

(71) Applicant: Xiamen University, Xiamen (CN)

(72) Inventors: BingWei Mao, Xiamen (CN); Yu Gu, Xiamen (CN); Hongyu Xu, Xiamen (CN); Weiwei Wang, Xiamen (CN); Jiawei Yan, Xiamen (CN); Quanfeng Dong, Xiamen (CN); Mingsen Zheng, Xiamen (CN)

(21) Appl. No.: 17/343,984

(22) Filed: Jun. 10, 2021

Related U.S. Application Data
(63) Continuation of application No. PCT/CN2019/108214, filed on Sep. 26, 2019.

(30) Foreign Application Priority Data
Dec. 11, 2018 (CN) 201811511263.3

(51) Int. Cl. H01M 4/66; H01M 4/74; H01M 4/04; H01M 10/0525

(52) U.S. Cl. CPC H01M 4/661; H01M 10/0525; H01M 4/0404; H01M 4/74

(57) ABSTRACT

The present disclosure discloses a current collector, and a surface of the current collector comprises a solid electrolyte interphase.

### RELATED APPLICATIONS

This application is a continuation of International patent application PCT/CN2019/108214, filed on Sep. 26, 2019, which claims priority to Chinese patent application 201811511263.3, filed on Dec. 11, 2018. International patent application PCT/CN2019/108214 and Chinese patent application 201811511263.3 are incorporated herein by reference.

### FIELD OF THE DISCLOSURE

The present disclosure relates to electrochemical technology, and in particular relates to a method for constructing solid electrolyte interphase on a current collector using a sacrificial lithium thin layer and an application method thereof.

### BACKGROUND OF THE DISCLOSURE

Lithium metal is a promising anode candidate for the next generation high-energy-density lithium batteries, such as lithium-sulfur and lithium-air batteries, due to its low electrochemical potential and low density. However, lithium anodes suffer from dendrite growth and infinite volume change during charge-discharge cycling. Additionally, the solid electrolyte interphase (SEI) usually cracks upon lithium deposition, which in turn exacerbates the dendrite growth and causes the formation of dead lithium, resulting in a poor cycling stability with continuous consumption of electrolyte as well as potential safety hazards. These issues greatly impede the realization of lithium anodes for practical applications. In view of the importance of lithium anodes, the mechanism of dendrite growth and SEI formation have been studied since the birth of the first lithium battery in the 1960s. The construction of ideal SEI with properties of compactness, stability, and coupled rigidity and elasticity has also become an extremely important and classical scientific issue in lithium anode research.

In recent years, with the demand of high-energy-density batteries and the development of characterization technologies, the research on lithium anodes has entered a revival period. Currently, most of the work has focused on the protection of lithium anodes by constructing artificial SEI layers, but the cycle efficiency and lifetime of batteries are far from the needs of practical requirements, and there are few approaches to create ideal SEIs and inhibit dendrite growth from the source. On the other hand, lithium thin film anodes with a quantified layer of lithium pre-stored on an appropriate current collector or even “lithium-free” anodes with bare current collectors as the hosts have been considered a viable strategy and brought to increasing attention for allowing the usage of lithium metal to be reduced and reducing safety concerns.

Furthermore, three-dimensional (3D) current collectors as the hosts for lithium thin film and lithium-free anodes are proposed with increasing levels of sophistication, enabling lithium anodes to work under lower real current density. However, the current work has mainly focused on the enhancement of the specific surface area of the 3D current collectors, but neglected the creation of high-quality SEIs on the 3D current collectors, which leads to the low utilization of their surface and internal space. As a result, the long-term stability and Coulombic efficiency of lithium anodes still need to be improved.

Actually, the construction of ideal SEI with properties of compactness, stability, and coupled rigidity and elasticity on current collectors can effectively suppress lithium dendrite growth and enable the high utilization of the surface and internal space of current collectors, thus significantly improving the cycling stability of lithium metal and promoting the practical applications of lithium anodes. Therefore, there is an urgent need to develop strategies to guide the preparation of stable and efficient lithium metal anodes and thus to drive the development of lithium-sulfur and lithium-air batteries.

### REFERENCES

Dingchang Lin, Yayuan Liu, and Yi Cui, Reviving the lithium metal anode for high-energy batteries, Nature Nanotechnology, 2017, 12, 194-206.

### BRIEF SUMMARY OF THE DISCLOSURE

A first technical solution of the present disclosure provides a current collector with a solid electrolyte interphase.

A second technical solution of the present disclosure provides a method for constructing the current collector with the solid electrolyte interphase.

A third technical solution of the present disclosure provides a method for applying the current collector with the solid electrolyte interphase.

In an embodiment, a current collector is provided, in which the current collector (e.g., a surface of the current collector) comprises a solid electrolyte interphase.

In an embodiment, a material of the current collector is at least one of metal and non-metal. The metal is at least one of copper, an alloy of copper, nickel, an alloy of nickel, etc. The non-metal is at least one of carbon, silicon, etc.

In an embodiment, a configuration of the current collector comprises at least one of a flat foil, a three-dimensional mesh, a three-dimensional foam, a three-dimensional cylinder, or a nanostructure.

In an embodiment, the current collector with the solid electrolyte interphase is prepared by introducing a sacrificial lithium layer followed by an electrochemical modulation method. The sacrificial lithium layer is lithium metal with a certain thickness prepared by an electrodeposition method or a non-electrodeposition method.

A method for preparing the current collector with the solid electrolyte interphase using the sacrificial lithium layer comprises the following steps:

1) introducing the sacrificial lithium layer: adding a current collector and a lithium metal foil (e.g., a lithium metal sheet) respectively functioning as a working electrode and a counter electrode into an electrolytic cell, injecting an electrolyte into the electrolytic cell, applying −0.2 V to −0.05 V of a cathodic potential or −0.1 mA/cm² to −0.05 mA/cm² of a cathodic current to the working electrode to enable lithium to be electrodeposited on the working electrode to obtain the sacrificial lithium layer with a thickness of 5 μm-30 μm, or heating to enable metal lithium to be melted to obtain molten lithium metal, dipping the current collector into the molten lithium metal for a preset time, then taking the current collector out, and cooling to room temperature to obtain the sacrificial lithium layer with the thickness of 5 μm-30 μm.

2) obtaining the solid electrolyte interphase: applying 0.2 V to 2.0 V of an anodic potential or 100 mA/cm² to 300 mA/cm² of an anodic current to the working electrode to enable the sacrificial lithium layer disposed on the working electrode to be stripped in steps, and reducing the electrolyte in steps to obtain a lithium-rich, dense, compositionally adjustable solid electrolyte interphase having an alternating inorganic-organic multilayer structure.

3) applying 0.05 V to 1.2 V of an anodic potential or 0.01 mA/cm² to 5 mA/cm² of an anodic current to the working electrode to enable a residual sacrificial lithium layer disposed on the working electrode to be completely stripped to obtain the current collector with the solid electrolyte interphase (e.g. a stable solid electrolyte interphase).

In an embodiment, a lithium salt used in the electrolyte in steps 1) to 3) is at least one of lithium imide, lithium perchlorate, lithium borate, fluorine-containing lithium compound, etc. As an example of the lithium salt, the lithium salt can be LiClO₄, LiPF₆, LiBF₄, LiAsF₆, LiSbF₆, LiCF₃SO₃, LiCF₃CO₂, LiC₂F₄(SO₃)₂, LiN(C₂F₅SO₂)₂, LiC(CF₃SO₂)₃, LiCₙF₂ₙ+1SO₃(n≥2), LiN(RfOSO₂)₂ (wherein Rf is a fluoroalkyl), etc. In the lithium salt, lithium imide is preferred. A concentration of the lithium salt in a non-aqueous electrolyte is, for example, preferably 0.3 M or more, more preferably 0.7 M or more, preferably 5 M or less, and more preferably 4 M or less. When the concentration of the lithium salt is too low, an ion conductivity is too low; when the concentration of the lithium salt is too high, there is a risk that the lithium salt that is not completely dissolved will be precipitated.

In an embodiment, a non-aqueous solvent (i.e., organic solvent) used in the electrolyte in steps 1) to 3) is at least one of carbonates, ethers, etc. The carbonates comprise at least one of cyclic carbonates or chain carbonates. The cyclic carbonates comprise at least one of, for example, ethylene carbonate, propylene carbonate, butylene carbonate, γ-butyrolactone, thioesters (ethylene glycol sulfide), etc. Chain carbonates comprise at least one of, for example, low-viscosity polar chain carbonates, aliphatic side chain carbonate, etc. The low-viscosity polar chain carbonates comprise at least one of dimethyl carbonate, diethyl carbonate, ethyl methyl carbonate, etc. The ethers comprise at least one of, for example, tetraethylene glycol dimethyl ether, ethylene glycol dimethyl ether, 1,3-dioxolane, etc. The ethers are particularly preferred.

In addition, various additives configured to improve a performance of lithium electrodeposition can also be added in the non-aqueous electrolyte and are not particularly limited thereto.

A method comprises the following steps: applying the current collector with the solid electrolyte interphase to function as a lithium-free anode in a lithium-ion battery, or applying the current collector with the solid electrolyte interphase prepared by electrodeposition or a molten lithium covering method in a lithium thin film anode of a secondary battery. The secondary battery comprises one of a lithium-ion battery, a lithium-sulfur battery, or a lithium-oxygen battery. A cathode material, an electrolyte, and a separator are a conventional cathode material, a conventional electrolyte, and a conventional separator of the lithium-ion battery, the lithium-sulfur battery, or the lithium-oxygen battery.

Compared with the existing techniques, the present disclosure has the following advantages.

1. The present disclosure uses the sacrificial lithium thin layer to construct the solid electrolyte interphase, realizing the construction of the solid electrolyte interphase with superior performance on the skeleton of the copper current collector and providing a stable lithium-electrolyte interface for the subsequent lithium thin film anode or lithium-free anode.

2. A thin, uniform, and quantitatively controllable sacrificial lithium layer is introduced on the surface of the current collector by electrodeposition or non-electrodeposition approaches. Combined with subsequent electrochemical control, a uniform solid electrolyte interphase film that closely adheres to the skeleton of the current collector is obtained, which is conducive to maintaining the cycle stability of the lithium-electrolyte interface.

3. Through electrochemical regulation, the anodic dissolution of the lithium thin layer and the reduction of the electrolyte are carried out in steps, which promotes the formation of a lithium-rich, dense, alternating inorganic-organic multilayer solid electrolyte interphase film, and the formed solid electrolyte interphase has mechanical properties of coupled rigidity and elasticity, which can effectively inhibit the growth of lithium dendrites.

4. The solid electrolyte interphase prepared in the current collector can achieve high utilization of the surface and electroactive space of the current collector or the lithium thin film anode and thus exhibits superior electrochemical performance, which provides the possibility for creating a near-perfect lithium metal anode for lithium-ion batteries, lithium-sulfur batteries, and lithium-air batteries, etc.

5. The present disclosure can be extended to various current collectors of other alkali metals, other configurations, and other materials.

### BRIEF DESCRIPTION OF THE DRAWINGS

FIGS. 1a and 1b illustrate scanning electron micrographs (SEMs) of lithium deposition morphologies on a normal copper foam current collector and a copper foam current collector with a solid electrolyte interphase prepared by a sacrificial lithium thin layer according to Embodiment 7. FIG. 1a illustrates a lithium deposition morphology on the normal copper foam current collector, and FIG. 1b illustrates a lithium deposition morphology on the copper foam current collector with the solid electrolyte interphase prepared by the sacrificial lithium thin layer according to Embodiment 7.

FIGS. 2a and 2b illustrate performance diagrams of the normal copper foam current collector and a copper foam current collector with a solid electrolyte interphase prepared by a sacrificial lithium thin layer according to Embodiment 12 directly used as lithium-free electrodes. FIG. 2a illustrates a cycle Coulombic efficiency diagram at 4 mA/cm² (1 mAh/cm²) of a copper-lithium battery comprising the normal copper foam current collector and a metal lithium electrode, and FIG. 2b illustrates a cycle Coulombic efficiency diagram at 4 mA/cm² (1 mAh/cm²) of a copper-lithium battery comprising the copper foam current collector with the solid electrolyte interphase prepared by the sacrificial lithium thin layer according to Embodiment 11 and a metal lithium electrode.

FIGS. 3a and 3b illustrate performance diagrams of various lithium-ion batteries. FIG. 3a illustrates a performance diagram of a lithium-ion battery comprising a normal copper foil current collector and lithium iron phosphate, and FIG. 3b illustrates a performance diagram of a lithium-ion battery prepared according to Embodiment 25.

FIGS. 4a and 4b illustrate performance diagrams of various lithium-ion batteries. FIG. 4a illustrates a performance diagram of a lithium-ion battery comprising a lithium electrode and lithium iron phosphate, in which 5 mAh·cm⁻² of lithium was introduced on a normal copper foil current collector by electrodeposition to form the lithium electrode, and FIG. 4b illustrates is a performance diagram of a lithium-ion battery prepared according to Embodiment 26.

### DETAILED DESCRIPTION OF THE EMBODIMENTS

The present disclosure will be further disclosed below in combination with the accompanying embodiments and drawings. The specific embodiments are as follows, but the scope of the present disclosure is not limited to the specific embodiments described below and covers any combinations of the specific embodiments.

### Embodiment 1

A method for constructing a solid electrolyte interphase on a current collector using a sacrificial lithium thin layer (i.e., sacrificial lithium layer) is as follows:

1) Introducing a sacrificial lithium thin layer: a current collector and a lithium metal foil (e.g., a lithium metal sheet) were added into an electrolytic cell and were functioning as a working electrode and a counter electrode, respectively. Electrolyte was injected into the electrolytic cell, and −0.2 V to −0.05 V of a cathodic potential or −2 mA/cm² to −0.05 mA/cm² of a cathodic current was applied to the working electrode to enable lithium to be electrodeposited on the working electrode to obtain the sacrificial lithium thin layer with a thickness of 5 μm-30 μm; or metal lithium was heated to be melted to obtain molten lithium metal, the current collector was dipped in the molten lithium metal for a certain period of time (i.e., a preset time), and then taken out to cool to room temperature (i.e., 20° C.-28° C.) to obtain the sacrificial lithium thin layer with the thickness of 5 μm-30 μm;

2) Constructing the solid electrolyte interphase: after step 1) was completed, 0.2 V-2.0 V of an anodic potential or 100 mA/cm²-300 mA/cm² of an anodic current was applied to the working electrode to enable the sacrificial lithium thin layer disposed on the working electrode to be stripped in steps. At the same time, the electrolyte was reduced in steps to obtain a lithium-rich, dense, compositionally adjustable solid electrolyte interphase having an alternating inorganic-organic multilayer structure; and

3) Dissolving the sacrificial lithium thin film layer: after step 2) was completed, 0.05 V-1.2 V of an anodic potential or 0.01 mA/cm²-5 mA/cm² of an anodic current was applied to the working electrode to enable the residual sacrificial lithium thin layer disposed on the working electrode to be completely stripped, and thus a current collector with a stable solid electrolyte interphase was obtained.

In some embodiments, a lithium salt used in the electrolyte in steps 1) to 3) was at least one of lithium imide, lithium perchlorate, lithium borate, or fluorine-containing lithium compound, a concentration of the lithium salt in a non-aqueous electrolyte was 0.3 M-4 M, and a non-aqueous solvent used in the electrolyte was at least one of carbonates or ethers.

### Embodiment 2

This embodiment differs from Embodiment 1 in that in step 1), a copper mesh was used as the working electrode and the cathodic potential applied to the working electrode was −0.2 V to enable lithium to be electrodeposited on the working electrode to obtain the sacrificial lithium thin layer with a thickness of 5 μm. The rest of the process was the same as the process of Embodiment 1.

### Embodiment 3

This embodiment differs from Embodiment 1 in that in step 1), a copper mesh was used as the working electrode and the cathodic potential applied to the working electrode was −0.05 V to enable lithium to be electrodeposited on the working electrode to obtain the sacrificial lithium thin layer with a thickness of 30 μm. The rest of the process was the same as the process of Embodiment 1.

### Embodiment 4

This embodiment differs from Embodiment 1 in that in step 1), a copper foam was used as the working electrode and the cathodic potential applied to the working electrode was −0.1 V to enable lithium to be electrodeposited on the working electrode to obtain the sacrificial lithium thin layer with a thickness of 15 μm. The rest of the process was the same as the process of Embodiment 1.

### Embodiment 5

This embodiment differs from Embodiment 1 in that in step 1), a copper mesh was used as the working electrode and the cathodic current applied to the working electrode was −2 mA/cm² to enable lithium to be electrodeposited on the working electrode to obtain the sacrificial lithium thin layer with a thickness of 5 μm. The rest of the process was the same as the process of Embodiment 1.

### Embodiment 6

This embodiment differs from Embodiment 1 in that in step 1), a copper foam was used as the working electrode, and the cathodic current applied to the working electrode was −0.05 mA/cm² to enable lithium to be electrodeposited on the working electrode to obtain the sacrificial lithium thin layer with a thickness of 15 μm. The rest of the process was the same as the process of Embodiment 1.

### Embodiment 7

This embodiment differs from Embodiment 1 in that in step 1), a copper foam was used as the working electrode and the cathodic current applied to the working electrode was −1 mA/cm² to enable lithium to be electrodeposited on the working electrode to obtain the sacrificial lithium thin layer with a thickness of 30 μm. The rest of the process was the same as the process of Embodiment 1.

### Embodiment 8

This embodiment differs from Embodiment 1 in that in step 1), a copper foil was used as the working electrode, the metal lithium was heated to be melted, and the copper foil was dipped for the certain period of time, and then taken out to cool to the room temperature to obtain the sacrificial lithium thin layer with a thickness of 25 μm. The rest of the process was the same as the process of Embodiment 1.

### Embodiment 9

This embodiment differs from Embodiment 1 in that in step 2), a copper mesh was used as the working electrode and the anodic potential applied to the working electrode was 0.2 V to enable the sacrificial lithium thin layer disposed on the working electrode to be stripped. At the same time, the electrolyte was reduced. The rest of the process was the same as the process of one of Embodiments 1-8.

### Embodiment 10

This embodiment differs from Embodiment 1 in that in step 2), a copper mesh was used as the working electrode and the anodic potential applied to the working electrode was 2.0 V to enable the sacrificial lithium thin layer disposed on the working electrode to be stripped in steps. At the same time, the electrolyte was reduced. The rest of the process was the same as the process of one of Embodiments 1-8.

### Embodiment 11

This embodiment differs from Embodiment 1 in that in step 2), a copper mesh was used as the working electrode and the anodic potential applied to the working electrode was 1.0 V to enable the sacrificial lithium thin layer disposed on the working electrode to be stripped. At the same time, the electrolyte was reduced. The rest of the process was the same as the process of one of Embodiments 1-8.

### Embodiment 12

This embodiment differs from Embodiment 1 in that in step 2), a copper foam was used as the working electrode. The anodic potential applied to the working electrode was first 1.6 V, then 0.6 V, then 1.0 V, and finally 0.6 V to enable the sacrificial lithium thin layer disposed on the working electrode to be stripped in steps. At the same time, the electrolyte was reduced in steps. The rest of the process was the same as the process of one of Embodiments 1-8.

### Embodiment 13

This embodiment differs from Embodiment 1 in that in step 2), a copper mesh was used as the working electrode and the anodic current applied to the working electrode was 100 mA/cm² to enable the sacrificial lithium thin layer disposed on the working electrode to be stripped. At the same time, the electrolyte was reduced. The rest of the process was the same as the process of one of Embodiments 1-8.

### Embodiment 14

This embodiment differs from Embodiment 1 in that in step 2), a nanostructured copper was used as the working electrode and the anodic current applied to the working electrode was 300 mA/cm² to enable the sacrificial lithium thin layer disposed on the working electrode to be stripped. At the same time, the electrolyte was reduced. The rest of the process was the same as the process of one of Embodiments 1-8.

### Embodiment 15

This embodiment differs from Embodiment 1 in that in step 2), a copper foam was used as the working electrode. The anodic current applied to the working electrode was first 300 mA/cm², then 100 mA/cm², and finally 200 mA/cm² to enable the sacrificial lithium thin layer disposed on the working electrode to be stripped in steps. At the same time, the electrolyte was reduced in steps. The rest of the process was the same as the process of one of Embodiments 1-8.

### Embodiment 16

This embodiment differs from Embodiment 1 in that in step 3), a copper foam was used as the working electrode and the anodic potential applied to the working electrode was 0.05 V to enable the residual sacrificial lithium thin layer disposed on the working electrode to be completely stripped. The rest of the process was the same as the process of one of Embodiments 1-15.

### Embodiment 17

This embodiment differs from Embodiment 1 in that in step 3), a copper foam was used as the working electrode and the anodic potential applied to the working electrode was 1.2 V to enable the residual sacrificial lithium thin layer disposed on the working electrode to be completely stripped. The rest of the process was the same as the process of one of Embodiments 1-15.

### Embodiment 18

This embodiment differs from Embodiment 1 in that in step 3), a copper foam was used as the working electrode and the anodic potential applied to the working electrode was 0.5 V to enable the residual sacrificial lithium thin layer disposed on the working electrode to be completely stripped. The rest of the process was the same as the process of one of Embodiments 1-15.

### Embodiment 19

This embodiment differs from Embodiment 1 in that in step 3), a copper mesh was used as the working electrode and the anodic current applied to the working electrode was 0.01 mA/cm² to enable the residual sacrificial lithium thin layer disposed on the working electrode to be completely stripped. The rest of the process was the same as the process of one of Embodiments 1-15.

### Embodiment 20

This embodiment differs from Embodiment 1 in that in step 3), a copper foam was used as the working electrode and the anodic current applied to the working electrode was 5 mA/cm² to enable the residual the sacrificial lithium thin layer disposed on the working electrode to be completely stripped. The rest of the process was the same as the process of one of Embodiments 1-15.

### Embodiment 21

This embodiment differs from Embodiment 1 in that in step 3), a copper foam was used as the working electrode and the anodic current applied to the working electrode was 1 mA/cm² to enable the residual the sacrificial lithium thin layer disposed on the working electrode to be completely stripped. The rest of the process was the same as the process of one of Embodiments 1-15.

### Embodiment 22

This embodiment differs from Embodiment 1 in that in step 1), a nickel foam was used as the working electrode and the cathodic potential applied to the working electrode was −0.1 V to enable lithium to be electrodeposited on the working electrode to obtain the sacrificial lithium thin layer with a thickness of 15 μm. In step 2), the anodic potential applied to the working electrode was 1.0 V to enable the sacrificial lithium thin layer disposed on the working electrode to be stripped. At the same time, the electrolyte was reduced. In step 3), the anodic current applied to the working electrode was 0.1 mA/cm² to enable the residual sacrificial lithium thin layer disposed on the working electrode to be completely stripped. The rest of the process was the same as the process of Embodiment 1.

### Embodiment 23

This embodiment differs from Embodiment 1 in that in step 1), a carbon paper was used as the working electrode and the cathode current applied to the working electrode was −0.05 mA/cm² to enable lithium to be electrodeposited on the working electrode to obtain the sacrificial lithium thin film layer with a thickness of 25 μm. In step 2), the anodic potential applied to the working electrode was 1.0 V to enable the sacrificial lithium thin layer disposed on the working electrode to be stripped. At the same time, the electrolyte was reduced. In step 3), the anodic potential applied to the working electrode was 0.5 V to enable the residual sacrificial lithium thin layer disposed on the working electrode to be completely stripped. The rest of the process was the same as the process of Embodiment 1.

### Embodiment 24

After the stable solid electrolyte interphase on the current collector was obtained using the sacrificial lithium thin layer according to one or any combinations of Embodiments 1-23 or other embodiments, the current collector and lithium metal define a copper-lithium battery. 1.0 M (mol/L) of LiTFSI/DME-DOL (1/1, volume to volume (V/V)) was used as the electrolyte, and Celgard 2400 was used as a separator.

### Embodiment 25

After the stable solid electrolyte interphase on the current collector was obtained using the sacrificial lithium thin layer according to one or any combinations of Embodiments 1-23 or other embodiments, the current collector and lithium iron phosphate define a lithium-ion battery. 1.0 M of LiPF₆/EC-DMC-EMC (1/1/1, V/V/V) was used as the electrolyte, and Celgard 2400 was used as a separator.

### Embodiment 26

After the stable solid electrolyte interphase on the current collector was obtained using the sacrificial lithium thin layer according to one or any combinations of Embodiments 1-23 or other embodiments, 5 mAh·cm⁻² lithium was deposited on the current collector to obtain a lithium thin film electrode using electrodeposition. The current collector (i.e., the lithium thin film electrode) and lithium iron phosphate define a lithium-ion battery. 1.0 M of LiPF₆/EC-DMC-EMC (1/1/1, V/V/V) was used as the electrolyte, and Celgard 2400 was used as a separator.

### Embodiment 27

After the stable solid electrolyte interphase on the current collector was obtained using the sacrificial lithium thin layer according to one or any combinations of Embodiments 1-23 or other embodiments, 5 mAh·cm⁻² lithium was deposited on the current collector to obtain a lithium thin film electrode using electrodeposition. The current collector (i.e., the lithium thin film electrode) and a sulfur cathode define a lithium-sulfur battery. 1.0 M of LiTFSI+0.5 M LiNO₃/DME-DOL (1/1, V/V) was used as the electrolyte, and Celgard 2400 was used as a separator.

### Embodiment 28

After the stable solid electrolyte interphase of the current collector was obtained using the sacrificial lithium thin layer according to one or any combinations of Embodiments 1-23 or other embodiments, 5 mAh·cm⁻² lithium was introduced on the current collector to obtain a lithium thin film electrode (i.e., lithium thin film anode) by a molten lithium covering method, and the lithium thin film anode and a Super P positive electrode were then assembled to obtain a lithium-oxygen batter. 1.0 M of LiTFSI+0.5 M LiNO₃/DME-DOL (1/1, V/V) containing saturated oxygen was used as the electrolyte, and Celgard 2400 was used as a separator.

Test result analysis of the abovementioned embodiment is as follows.

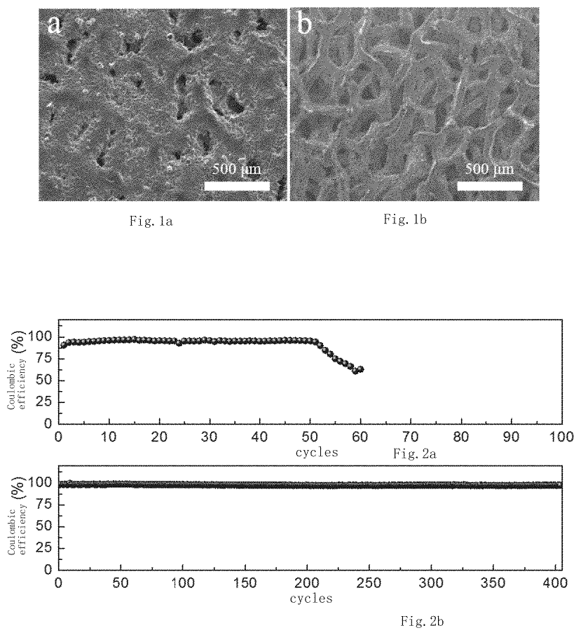

FIGS. 1a and 1b illustrate scanning electron micrographs (SEMs) of lithium deposition morphologies on a normal copper foam current collector and a copper foam current collector with a solid electrolyte interphase prepared by a sacrificial lithium thin layer according to Embodiment 7. FIG. 1a illustrates a lithium deposition morphology on the normal copper foam current collector, and FIG. 1b illustrates a lithium deposition morphology on the copper foam current collector with the solid electrolyte interphase prepared by the sacrificial lithium thin layer according to Embodiment 7. Referring to FIG. 1a, a lithium deposition on the normal copper foam current collector is very uneven, and deposited lithium metal blocks the pores of the normal copper foam current collector. Referring to FIG. 1b, the lithium deposition on the copper foam current collector with the solid electrolyte interphase prepared by the sacrificial lithium thin layer, the deposited lithium metal grows closely confined to the skeleton of the copper foam current collector, and pores of the copper foam current collector are not blocked. These results indicate that the stable solid electrolyte interphase ensures uniform deposition and growth of lithium and a high utilization of surface and electroactive spaces of the three-dimensional structure.

FIGS. 2a and 2b illustrate performance diagrams of the normal copper foam current collector and a copper foam current collector with a solid electrolyte interphase prepared by a sacrificial lithium thin layer according to Embodiment 12. The normal copper foam current collector and metal lithium or the copper foam current collector with the solid electrolyte interphase prepared by the sacrificial lithium thin layer and metal lithium define a copper-lithium battery, respectively, cycling at 4 mA/cm² (1 mAh/cm²). FIG. 2a illustrates the normal copper foam current collector, and FIG. 2b illustrates the copper foam current collector with the solid electrolyte interphase prepared by the sacrificial lithium thin layer according to Embodiment 12. Referring to FIGS. 2a and 2b, the lithium metal on the normal copper foam collector can be only circulated for about 50 cycles, and a Coulombic efficiency is only 95%. The lithium metal on the copper foam current collector with the solid electrolyte interphase prepared by the sacrificial lithium thin layer according to Embodiment 12 can be stably circulated for at least 400 cycles, and a Coulombic efficiency is as high as 97.5%. Therefore, the three-dimensional current collector with the solid electrolyte interphase prepared by the sacrificial lithium thin layer shows a significantly improved Coulombic efficiency and significantly prolonged cycle stability.

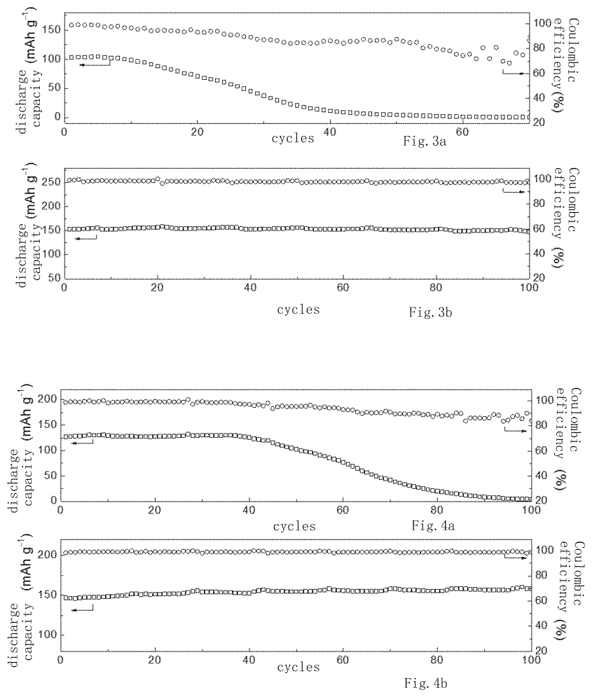

FIGS. 3a and 3b illustrate performance diagrams of various lithium-ion batteries. FIG. 3a illustrates a performance diagram of a lithium-ion battery comprising a normal copper foil current collector and lithium iron phosphate, and FIG. 3b illustrates a performance diagram of a lithium-ion battery prepared according to Embodiment 25. Referring to FIGS. 3a and 3b, after the normal copper foil current collector and lithium iron phosphate define a lithium-ion battery, the lithium-ion battery can be only circulated for about 40 cycles, and a Coulombic efficiency is only 93.6%. However, the lithium-ion battery prepared according to Embodiment 25 can be stably circulated for at least 100 cycles, and a Coulombic efficiency is as high as about 100%. Therefore, the current collector with the stable solid electrolyte interphase can be directly used as an anode to improve a performance of lithium-ion batteries.

FIGS. 4a and 4b illustrate performance diagrams of various lithium-ion batteries. FIG. 4a illustrates a performance diagram of a lithium-ion battery comprising a lithium electrode and lithium iron phosphate, in which 5 mAh·cm⁻² of lithium is introduced on the normal copper foil current collector by electrodeposition to form the lithium electrode, and FIG. 4b illustrates a performance diagram of a lithium-ion battery prepared according to Embodiment 26. Referring to FIGS. 4a and 4b, after the lithium electrode prepared using the normal copper foil current collector and lithium iron phosphate define the lithium-ion battery, the lithium-ion battery can be only circulated for about 10 cycles, and a Coulombic efficiency is only about 90%. However, the lithium-ion battery prepared according to Embodiment 26 can be stably circulated for at least 100 cycles, and a Coulombic efficiency is as high as about 97%. Therefore, the metal lithium thin film anode prepared by the current collector with the stable solid electrolyte interphase can improve a performance of the lithium-ion battery.

What is claimed is:

1. A current collector, wherein a surface of the current collector comprises a solid electrolyte interphase.

2. The current collector according to claim 1, wherein the solid electrolyte interphase defines a multilayer structure.

3. The current collector according to claim 1, wherein the solid electrolyte interphase defines an alternating inorganic-organic multilayer structure.

4. The current collector according to claim 1, wherein a material of the current collector is at least one of copper, an alloy of copper, nickel, an alloy of nickel, carbon, or silicon.

5. The current collector according to claim 1, wherein a configuration of the current collector comprises at least one of a flat foil, a three-dimensional mesh, a three-dimensional foam, a three-dimensional cylinder, or a nanostructure.

6. A method for preparing the current collector according to claim 1, comprising:
introducing a sacrificial lithium layer on the current collector,
stripping the sacrificial lithium layer on the current collector functioning as a working electrode in steps to obtain the solid electrolyte interphase.

7. A method comprise the following steps:
applying the current collector with the solid electrolyte interphase according to claim 1 to function as a lithium-free anode in a lithium-ion battery, or
applying the current collector with the solid electrolyte interphase prepared by an electrodeposition method or a molten lithium covering method in a lithium thin film anode of a secondary battery.

8. The method according to claim 7, wherein:
the secondary battery comprises one of a lithium-ion battery, a lithium-sulfur battery, or a lithium-oxygen battery.

9. A method for preparing a current collector with a solid electrolyte interphase, comprising:
1) adding a current collector and a lithium metal foil respectively functioning as a working electrode and a counter electrode into an electrolytic cell, injecting an electrolyte into the electrolytic cell, applying a cathodic potential or a cathodic current to the working electrode to enable lithium to be electrodeposited on the working electrode to obtain a sacrificial lithium layer, or
heating to enable metal lithium to be melted to obtain molten lithium metal, dipping the current collector into the molten lithium metal for a preset time, then taking the current collector out, and cooling to room temperature to obtain the sacrificial lithium layer, and
2) after step 1) is completed, applying an anodic potential or an anodic current to the working electrode to enable the sacrificial lithium layer disposed on the working electrode to be stripped in steps, and reducing the electrolyte in steps to obtain the solid electrolyte interphase.

10. The method for preparing the current collector with the solid electrolyte interphase according to claim 9, further comprising:
3) after step 2) is completed, applying an anodic potential or an anodic current to the working electrode to enable a residual sacrificial lithium layer disposed on the working electrode to be completely stripped to obtain the current collector with the solid electrolyte interphase.

11. The method for preparing the current collector with the solid electrolyte interphase according to claim 9, wherein the sacrificial lithium layer is lithium metal with a thickness of 5 μm-30 μm prepared by an electrodeposition method or a non-electrodeposition method.

12. The method for preparing the current collector with the solid electrolyte interphase according to claim 9, wherein in step 1), the cathodic potential is −0.2 V to −0.05 V, and the cathodic current is −2 mA/cm² to −0.05 mA/cm².

13. The method for preparing the current collector with the solid electrolyte interphase according to claim 9, wherein in step 2), the anodic potential is 0.2 V to 2.0 V, and the anodic current is 100 mA/cm² to 300 mA/cm².

14. The method for preparing the current collector with the solid electrolyte interphase according to claim 10, wherein in step 3), the anodic potential is 0.05 V to 1.2 V, and the anodic current is 0.01 mA/cm² to 5 mA/cm².

15. The method for preparing the current collector with the solid electrolyte interphase according to claim 10, wherein:
a lithium salt used in the electrolyte in steps 1) to 3) is at least one of lithium imide, lithium perchlorate, lithium borate, or fluorine-containing lithium compound,
a concentration of the lithium salt in a non-aqueous electrolyte is 0.3 M-4 M, and
a non-aqueous solvent used in the electrolyte is at least one of carbonates or ethers.
